(19) United States
(12) Patent Application Publication
(10) Pub. No.: US 2021/0201326 A1
(43) Pub. Date: Jul. 1, 2021

(54) USER CONTROLLED SHARING OF PERSONAL AND CONTACT INFORMATION USING A BLOCKCHAIN

(71) Applicant: LendingClub Corporation, San Francisco, CA (US)

(72) Inventor: Srinivas Ambikapathi, Fremont, CA (US)

(21) Appl. No.: 16/729,241

(22) Filed: Dec. 27, 2019

(51) Int. Cl. G06Q 20/42; H04L 9/06; G06Q 20/38; G06Q 20/40

(52) U.S. Cl. CPC G06Q 20/425; G06Q 20/4014; G06Q 20/3829; H04L 9/0637

(57) ABSTRACT

Techniques are provided for propagating updates to user profile information using a blockchain and for controlling access to user profile information using a blockchain. In one embodiment, a first block is added to a blockchain. The first block includes a first transaction ID that identifies a first transaction entry in the blockchain and a first version of user profile information encrypted using the first encryption key. The first transaction ID and a first decryption key that is able to decrypt information encrypted with the first encryption key is communicated to a plurality of entity computing devices that are to use the user profile information. The user profile information is updated by adding a second block to the blockchain that refers to the first transaction ID and includes a second version of the profile information encrypted using the first encryption key.

### TECHNICAL FIELD

One technical field of the present disclosure relates to improved methods, systems, computer software, and/or computer hardware in the field of distributed transaction computer systems. More particularly, the technology herein relates to computer systems and processes that interface with a blockchain.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by their inclusion in this section.

Sensitive personal information is commonly collected by many websites and applications that are affiliated with a variety of different entities. Users of such websites and applications commonly share the same personal information with each and every website or application that they use. When a user wants to change their personal information, such as when a user has new address or new phone number, the user must update their personal information individually at all the websites and applications that they are enrolled with.

Additionally, if a user wants to update any preference relating to their personal information, such as adding a DO NOT CONTACT preference for a particular email address or phone number, the user must manually interact with all the web sites and applications that store their personal information and update their personal information preferences with the DO NOT CONTACT preference. Likewise, if a user wants to delete their personal information from multiple websites or applications, the user must manually contact support associated with each of the websites and applications that store their personal information to ensure that their personal information deletion request was received and executed.

Based on the foregoing, techniques are desired that provide mechanisms for securely and efficiently communicating updates to personal information to multiple entities, and verifying that the multiple entities have received the updates.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 depicts an embodiment of a blockchain network.

FIG. 2 depicts a method for propagating updates to user profile information using a blockchain.

FIG. 3 depicts a method for controlling access to user profile information using a blockchain.

FIG. 4 depicts a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form to avoid unnecessarily obscuring the present invention.

### General Overview

Techniques are described herein for propagating updates to user profile information using a blockchain and for controlling access to user profile information using a blockchain. Specifically, the user profile information itself is stored in the blockchain. In addition, the same blockchain may indicate the entities that are allowed to read the profile information. Updates to the profile information may be performed by adding updated profile information to later blocks in the same blockchain.

The techniques described herein for using blockchains to manage user profile information provide the benefit of securely and efficiently propagating updates to user profile information across multiple entity accounts and controlling access to user profile information by multiple entity accounts. For example, instead of manually updating user profile information at each different entity account of multiple entity accounts, a user can update user profile information in a single location and propagate the update to multiple entity accounts using a blockchain network.

Additionally, by using a blockchain gateway to control access to a blockchain, all accesses including reads or writes to the blockchain can be recorded in the blockchain, providing immutable transparency to owners of personal data regarding who is accessing their data and how often it is being accessed. The use of blockchain gateways to govern access to the user information in blockchains shall be described in greater detail below.

Furthermore, by using a blockchain to propagate updates to user profile information across multiple entity accounts and control access to user profile information, the blockchain advantageously provides cryptographically safe storage and immutability for the user profile data that is stored on the blockchain. For example, since each block of a distributed blockchain contains a hash of the previous block before it, any unauthorized changes to data such as user profile information stored within the blockchain produces changes in the hash of the block to which the change was made. Therefore, unauthorized changes can easily be detected.

### Overview of Storing Profile Information in a Blockchain

To initially store user profile information in a blockchain, a block can be added to the blockchain, where the block stores (a) a transaction ID and (b) user profile information that is encrypted using an encryption key. The transaction ID and a decryption key that is able to decrypt information encrypted with the encryption key may be communicated to multiple entities that are to use the user profile information. Such entities may be, for example, websites or software applications.

The user profile information is updated by adding a new block to the blockchain. The new block (a) refers to the transaction ID and (b) includes an updated version of the profile information encrypted using the encryption key. Each of the multiple entities may monitor the blockchain to detect when new blocks that include a reference to the transaction ID are added to the blockchain. Once the addition to the blockchain of new block that includes the transaction ID is detected by an entity, the user profile information included in the new block can be decrypted by the entity using the decryption key.

### Overview of Blockchain Gateway Embodiments

In some embodiments, a blockchain gateway can be used to control access to blockchain. A blockchain gateway is a software module that serves as an entry point through which a blockchain can be accessed (i.e. read from or written to). According to an embodiment, to use the blockchain gateway, users and entities first enroll with the blockchain gateway by registering a user account or entity account with the blockchain gateway. The enrollment process provides credentials that are used to identify user and entity accounts who may submit requests to write to the blockchain or read from the blockchain. When the blockchain gateway receives a request to write data to or read from the blockchain, the blockchain gateway may perform authorization operations to verify that a user or entity account ID included in the request is authorized to read from or write to the blockchain.

When the blockchain gateway determines that a user or entity account is authorized to write to or read from the blockchain, the blockchain gateway may write data to the blockchain on behalf of the user or entity account ID included in the request. Similarly, the blockchain gateway may read data from the blockchain on behalf of the user or entity account ID included in the request and transmit the data, or a subset thereof, to a computing device associated with the requesting user or account ID. Additionally, when the blockchain gateway reads data from the blockchain on behalf of a user or entity account ID, the blockchain gateway may automatically publish an acknowledgement to the blockchain that indicates that the user or entity account ID has read the data from the blockchain.

### Blockchain Network Overview

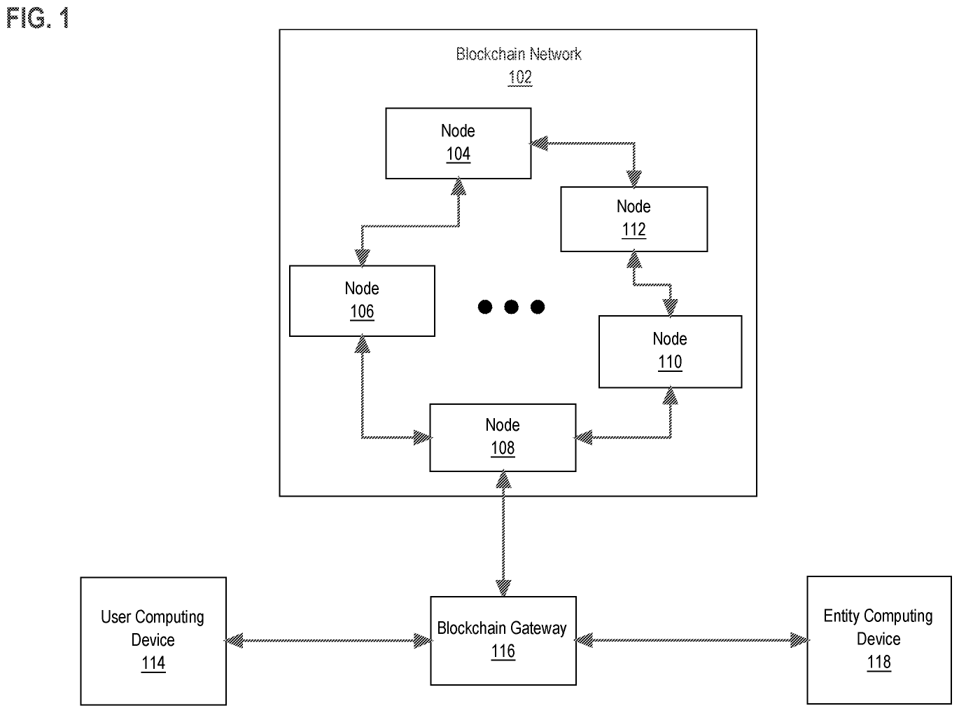

FIG. 1 depicts an embodiment of a blockchain network 102, which comprises a plurality of nodes 104, 106, 108, 110, 112, each of which may be implemented by a plurality of computing devices. Blockchain network 102 represents a computing environment for operating a decentralized framework that maintains a distributed data structure, which may be referred to herein as a secure distributed transaction ledger or a blockchain. This blockchain may support various functions, such as distributing computational tasks from one or more systems to one or more other systems, or interfacing and sharing data with other blockchains, among other functions.

To maintain the blockchain among the various nodes 104, 106, 108, 110, 112 in the blockchain network 102, a set of procedures are followed. Generally, such a network would suffer from inherent uncertainty and distrust between the nodes when they transact because they are typically unaffiliated with each other, may be transacting across vast distances, may be transacting anonymously, and because there is no centralized control or management to monitor or to resolve disputes. However, because the blockchain is maintained by each node 104, 106, 108, 110, 112 in the blockchain network 102 and because it is maintained according to set procedures that employ cryptographic methods and a consensus mechanism, the uncertain and distrust elements are mitigated.

Thus, the secure distributed transaction ledger, or blockchain, is a ledger maintained collectively by the nodes 104, 106, 108, 110, 112 in blockchain network 102. The blockchain may comprise a system of blocks containing digital data that are interconnected by reference to the previous block. The blocks can hold digital data including file transfer data, transaction data, message data, smart contract data, consensus data that ensures that the state of the blockchain is valid and is endorsed by the majority of the record keeping systems, and/or other information as desired. Each block may include a link to the previous block and may include a timestamp. Furthermore, all confirmed transactions are included in the blockchain and are done so using cryptography. This way, the integrity and the chronological order of the blockchain are enforced and can be independently verified by each node.

Digital data may be received by one or more nodes in the blockchain network 102 for inclusion in the blockchain. This digital data may be grouped into transaction entries and made available to the nodes in the blockchain network 102. One or more computing devices, such as user computing device 114, blockchain gateway 116, and entity computing device 118 may be configured to connect to the blockchain network to publish digital data to blocks of the blockchain. Although only one entity computing device is depicted in FIG. 1, embodiments may include multiple entity computing devices connected to blockchain network 102.

In some embodiments, user computing device 114 and entity computing device 118 may be in direct electronic communication with blockchain network 102. User computing device 114 and entity computing device 118 may interface directly with nodes 104, 106, 108, 110, 112 of blockchain network 102 using an application programming interface (API). User computing device 114 and entity computing device 118 may issue requests to nodes 104, 106, 108, 110, 112 of blockchain network 102 to write or publish digital data to the blockchain.

In some embodiments, user computing device 114 and entity computing device 118 may be in electronic communication with blockchain network 102 via blockchain gateway 116. Blockchain gateway 116 may comprise any suitable distributed-ledger based wallet that allows for the installation of smart contracts, such as, for example, Ethereum GETH, eth-lightwallet, and/or any other suitable blockchain interface technologies. Blockchain gateway 116 may serve as a blockchain interface accessible by applications installed on user computing device 114 and entity computing device 118. For example, blockchain gateway 116 may be configured to register accounts associated with user computing device 114 and entity computing device 118 with the blockchain such as user accounts that are each represented by a user account ID and entity accounts that are each represented by an entity account ID, write digital data to the blockchain according to a smart contract, write digital data to the blockchain, and request or generate encryption and decryption key pairs.

In some embodiments, blockchain gateway 116 may expose different functionality to user computing device 114 and entity computing device 118 to interact with blockchain network 102. For example, blockchain gateway 116 may include programmatic instructions that control access to blockchain network 102, as further discussed herein.

### Sharing Personal Data Using a Blockchain

Digital data stored in each block of a blockchain may comprise one or more transaction entries. A transaction entry may comprise transaction data. The transaction data may comprise one or more fields that represent information about a transaction. For example, transaction data may include a nonce field that identifies the number of transactions sent by an account that created the transaction, a transaction identification (ID) field that identifies the respective transaction entry in the blockchain, a sender field that identifies an address of a sender account, a destination field that identifies an address recipient account, and one or more payload fields. A field may be populated with a data value, referred to herein as a “field entry”.

In some embodiments, one or more payload fields and corresponding payload field entries, referred to herein as “payload data”, may be organized according to a specific format and stored as part of a transaction entry in the specific format. For example, payload data may be organized according to JavaScript Object Notation (JSON) syntax. As another example, payload data may be organized according to Extensible Markup Language (XML) syntax. The organization and/or formatting of such payload data may be provided by user computing device 114, entity computing device 118, and/or blockchain gateway 116 when a transaction is a created by a user.

Payload data may include user profile information. User profile information may include a variety of sensitive personal information such as, for example, name, age, address, email address, date of birth, social security number, account name, preferences etc. As an example, user profile information represented by multiple payload fields and corresponding payload field entries may be organized according to JSON syntax in the string: {“name”:“John”, email address”: “john@xyz.com”}. In this example, the payload field “name” and corresponding payload field entry “John” are concatenated with the payload field “email address” and corresponding payload field entry “john@xyz.com” to create a payload string.

In some embodiments, payload data may include preferences that specify restrictions with respect to selections of the payload data. Preferences can specified be at any level of granularity such as individual fields, groups of fields, or for all fields included in payload data. As an example, permissions represented by multiple data fields and corresponding data field entries may be organized according to JSON syntax in the string: {“name”:“John”, ““age”: 30, “email address”: john@john.com, “do not contact”: true}. In this example, the payload field “do not contact” identifies that any personal information that may be used to contact a user associated with the transaction entry should not be used for contacting the user associated with the transaction entry. The payload field “do not contact” is concatenated with the corresponding payload field entry “true” and the rest of the user profile information to create a payload string.

In some embodiments, payload data may include a whitelist of entities that are allowed to interact with the payload data in the respective transaction entry. As an example, a whitelist of entities represented by a payload field and corresponding payload field entries may be organized according to JSON syntax in the string: {“whitelist”: “Facebook”, “Instagram”, “Youtube”}. In this example, the payload field “whitelist” identifies that accounts corresponding to the entities “Facebook”, “Instagram”, and “Youtube” are allowed to interact with the payload data in the respective transaction entry. The payload field “whitelist” is concatenated with the corresponding payload field entries “Facebook”, “Instagram”, and “Youtube” to create a payload string.

In some embodiments, payload data may include a blacklist of entities that are not allowed to interact with the data in the respective transaction entry. As an example, a blacklist of entities represented by a payload field and corresponding payload field entries may be organized according to JSON syntax in the string {“whitelist”: “Snapchat”, “Amazon”, “Zappos”}. In this example, the payload field “blacklist” identifies that accounts corresponding to the entities “Snapchat”, “Amazon”, and “Zappos” are not allowed to interact with the payload data in the respective transaction entry. The payload field “blacklist” is concatenated with the corresponding payload field entries “Snapchat”, “Amazon”, “Zappos”. to create a payload string.

In some embodiments, before payload data is stored as part of a transaction entry in a block of a blockchain, the payload data can be encrypted using an encryption key. In some embodiments, asymmetric encryption techniques can be used such that when payload data is encrypted using an encryption key, the payload data can only be decrypted using a decryption key that is paired with the encryption key. In other embodiments, symmetric encryption techniques can be used such that when payload data is encrypted using a particular encryption key, the payload data can only be decrypted using the same particular encryption key that was used to encrypt the payload data.

Once a transaction entry is written to a blockchain with encrypted payload data, the transaction ID of the transaction entry and decryption key (in the case of asymmetric encryption) can be communicated to one or more entities that desire to use user profile information included in the encrypted payload data. For example, user computing device 114 may transmit a transaction ID and decryption key to entity computing device 118. Once received by entity computing device 118, the transaction entry corresponding to the transaction ID can be accessed and the encrypted payload data can be decrypted using the decryption key. User profile information that is included as part of the payload data can then be utilized by the receiving entity.

### Propagating Updates of Personal Data Using a Blockchain

To update a first version of user profile information included in payload data of a first transaction entry in blockchain, a second transaction entry can be added to the blockchain that includes payload data with a second version of the user profile information. In some embodiments, the second transaction entry may include a reference to a transaction ID of the first transaction entry that includes the first version of the user profile information.

In some embodiments, to identify that an updated version of user profile information has been written to a blockchain, a computing device such as entity computing device 118 may continuously monitor new transaction entries stored in the blockchain for a reference to the transaction ID of the first transaction entry that includes the first version of user profile information. In this embodiment, any new transaction entry that references the transaction ID of the first transaction entry is identified as a transaction entry that may include an update to the first version of user profile information.

In other embodiments, to identify that an updated version of user profile information has been written to a blockchain, a computing device such as entity computing device 118 may continuously monitor new transaction entries stored in the blockchain for transaction entries associated with the address of a sender account of the first transaction. In this embodiment, any new transaction entry from the address of the sender account of the first transaction is identified as a transaction entry that may include an update to the first version of user profile information.

For example, a first transaction entry created by user computing device 114 with transaction ID: ‘99999’ may include payload data with a first version of user profile information represented by the JSON string: {“name”:“John”, “city”: “San Francisco”, “state”: “California”}. The payload data with the first version of user profile information may be encrypted using an encryption key and published to a blockchain. The first transaction ID and decryption key may then be communicated by user computing device 114 to entity computing device 118. To update the first version of user profile information, user computing device 114 may create a second transaction entry with payload data that includes a second version of the user profile information represented by the JSON string: {“name”:“John”, “city”: “Scranton”, “state”: “Pennsylvania”}. The payload data with the second version of user profile information may be encrypted using the encryption key and published to the blockchain. The second transaction entry may also include a reference to the transaction ID ‘99999’ of the first transaction entry. To identify the update, entity computing device 118 scans each new transaction entry written to the blockchain for a reference to transaction ID: ‘99999’. When a new transaction entry that refers to transaction ID: ‘99999’ is identified, the new transaction entry is identified as a transaction entry that includes an update to the first version of user profile information.

Once entity computing device 118 identifies a particular transaction entry that includes an update to the first version of user profile information, entity computing device 118 may read the particular transaction entry to access the encrypted payload data that includes the first version of user profile information. The encrypted payload data that includes the first version of user profile information may then be decrypted by entity computing device 118 using the decryption key that was provided with the transaction ID of the first transaction entry.

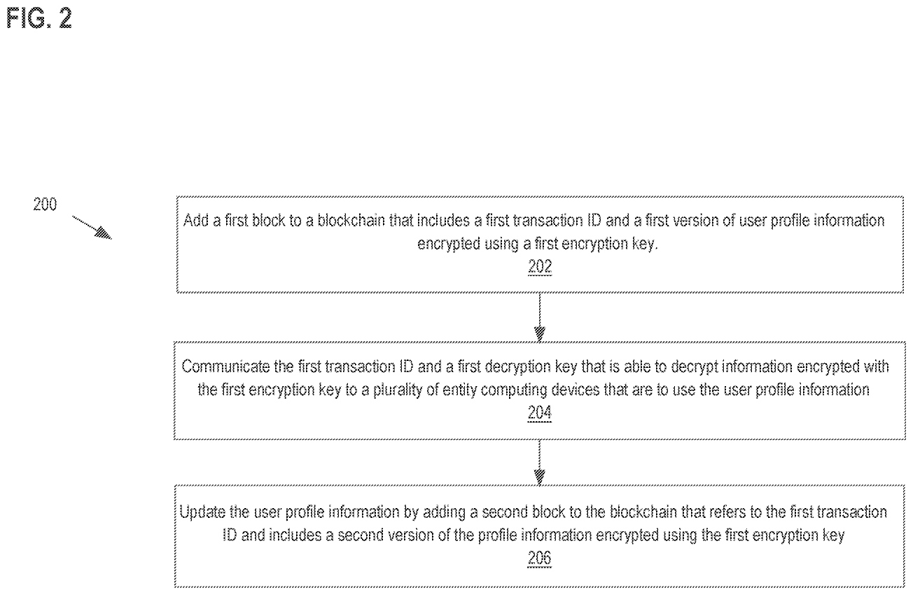

FIG. 2 depicts a method for propagating updates to user profile information using a blockchain, in an example embodiment. FIG. 2 is described at the same level of detail that is ordinarily used, by persons of skill in the art to which this disclosure pertains, to communicate among themselves about algorithms, plans, or specifications for other programs in the same technical field. While the algorithm or method of FIG. 2 shows a plurality of steps, the algorithm or method described herein may be performed using any combination of one or more steps of FIG. 2 in any order, unless otherwise specified.

For purposes of illustrating a clear example, FIG. 2 is described herein in the context of FIG. 1, but the broad principles of FIG. 2 can be applied to other systems having configurations other than as shown in FIG. 1. Further, FIG. 2 and each other flow diagram herein illustrates an algorithm or plan that may be used as a basis for programming one or more of the functional modules of FIG. 1 that relate to the functions that are illustrated in the diagram, using a programming development environment or programming language that is deemed suitable for the task. Thus, FIG. 2 and each other flow diagram herein are intended as an illustration at the functional level at which skilled persons, in the art to which this disclosure pertains, communicate with one another to describe and implement algorithms using programming. The flow diagrams are not intended to illustrate every instruction, method object or sub step that would be needed to program every aspect of a working program, but are provided at the high, functional level of illustration that is normally used at the high level of skill in this art to communicate the basis of developing working programs.

At step 202, a first block is added to a blockchain. The first block includes a first transaction entry that includes a first transaction ID and a first version of user profile information encrypted using a first encryption key. For example, user computing device 114 may generate a request to publish a transaction entry to a blockchain. The request may be generated at user computing device 114 or blockchain gateway 114 using a graphical user interface (GUI) that is associated with programmatic logic that receives input via GUI from a user of user computing device 114 and formats the received input into a first transaction entry that includes a first transaction ID and a first version of user profile information encrypted using a first encryption key. The first transaction entry may be transmitted to a node of blockchain network 102, and the receiving node may publish the first transaction entry to a blockchain associated with blockchain network 102.

At step 204, the first transaction ID and a first decryption key that is able to decrypt information encrypted with the first encryption key are communicated to a plurality of entity computing devices that are to use the user profile information. Each of the plurality of entity computing devices may be represented by an entity account that corresponds to a business entity. For example, an entity account may be represented by a Facebook account, a Twitter account, or any business entity that is to use the user profile information included in the first transaction entry of the first block. Communicating the first transaction ID and the first decryption to the plurality of entity computer devices may be accomplished by the user computing device 114 or a node of blockchain network 102 transmitting the information to the plurality of entity computing devices.

At step 206, the user profile information is updated by adding a second block to the blockchain that refers to the first transaction ID and includes a second version of the profile information encrypted using the first encryption key. The second block includes a second transaction entry includes a reference to the first transaction ID and a second version of the profile information that is encrypted using the first encryption key. For example, user computing device 114 may generate a request to publish a second transaction entry to a blockchain. The request may be generated at user computing device 114 or blockchain gateway 114 using a graphical user interface (GUI) that is associated with programmatic logic that receives input via GUI from a user of user computing device 114 and formats the received input into a second transaction entry that that refers to the first transaction ID and includes a second version of the profile information encrypted using the first encryption key.

By monitoring the blockchain, entity computing device 118 can identify that an updated version of user profile information has been written to the blockchain based on determining that the second transaction entry in the second block includes a reference to the first transaction ID. Once identified, the updated version of user profile information can be decrypted by entity computing device 118 using the first decryption key. The decrypted personal profile information can then be used by entity computing device 118 for any purpose, such as updating user profile information stored is association with an entity account at the entity computing device 118.

In some embodiments, to restrict access to updates to user profile information, a new version of user profile information may be encrypted with an encryption key that is different than the first encryption key and added to a new block of the blockchain. A new decryption key that is able to decrypt information encrypted with the new encryption key and a new transaction ID may be communicated to a subset of entity computing devices of the plurality of entity computing devices that are to use the user profile information. Using this method, entity computing devices that do not receive the new decryption key and new transaction ID will not be able to decrypt the new version of user profile information, and thus, are restricted from reading the updates to the user profile information.

In some embodiments, in addition to the user profile information, a transaction entry may store a whitelist or blacklist. In this scenario, when entity computing device 118 decrypts the encrypted payload data, entity computing device 118 may identify that an entity account ID associated with entity computing device 118 is included in the whitelist or blacklist. In this scenario, entity computing device 118 may include programmatic instructions that cause the entity computing device 118 to take an action in response such an identification. For example, in response to identifying that a blacklist includes an entity account ID associated with entity computing device 118, entity computing device 118 restricts all further actions taken by entity computing device 118 with respect to the transaction entry.

The above described embodiments provide the benefit of securely and efficiently propagating updates to user profile information across multiple entity accounts. For example, instead of manually updating user profile information manually at each different entity account of multiple entity accounts, a user can update user profile information in a single location and propagate the update to multiple entity accounts using a blockchain network. In addition, by using a blockchain in tandem with encrypting the user profile data that is stored in the blockchain, the blockchain advantageously provides cryptographically safe storage and immutability for the user profile data that is stored on the blockchain. For example, since each block of a distributed blockchain contains a hash of the previous block before it, any unauthorized changes to data such as user profile information stored within the blockchain produces changes in the hash of each block in the chain. Therefore, unauthorized changes can easily be detected through the use of blockchain to store user profile information.

### Controlling Access to Personal Data Using a Blockchain

Blockchain gateway 116 can be used to control access to blockchain network 102. In some embodiments, blockchain gateway 116 is an entry point to which the blockchain supported by blockchain network 102 can be accessed (i.e. read from or written to).

Blockchain network 102 may include a blockchain that is permissioned. A blockchain may be permissioned such that when a request to write to the blockchain is received by a node, the receiving node must verify that an account ID associated with the request is authorized to write to the blockchain. In some embodiments, blockchain gateway 116 is authorized to write to the blockchain, but user computing device 114 and entity computing device 118 are not. Thus, in order to write to the blockchain, user computing device 114 and entity computing device 118 must submit write requests through blockchain gateway 116.

Similarly, a blockchain may be permissioned such that a node of the blockchain network 102 may only allow the digital data stored in the blockchain to be read by an authorized account ID. For example, when a request to read from the blockchain supported by blockchain is received by a node, the receiving node must verify that an account ID associated with the request is authorized to read from the blockchain. In some embodiments, the blockchain gateway 116 is authorized to read from the blockchain, but user computing device 114 and entity computing device 118 are not. Thus, in order to read from the blockchain, user computing device 114 and entity computing device 118 must submit read requests through blockchain gateway 116.

Blockchain gateway 116 may prevent the publishing of digital data to a block of the blockchain and reading of digital data from a block of the blockchain if the identification information of a requestor is not authorized. Similarly, blockchain gateway 116 may allow the publishing of digital data to a block of the blockchain and reading of digital data from a block of the blockchain if the identification information of a requestor is authorized.

In some embodiments, to read from or write to a blockchain supported by blockchain network 102, users and entities must first enroll through blockchain gateway 116 by registering a user account or entity account. The enrollment process provides credentials that are used to identify user and entity accounts associated with a user computing device 114 or entity computing device 118 when a request is received to perform transactions such as reading from the blockchain and publishing to the blockchain.

When blockchain gateway 116 receives a request to write data to or read from a blockchain supported by blockchain network 102, blockchain gateway 116 may perform authorization operations to verify that a user or entity account ID included in the request is authorized to read from or write to the blockchain. For example, blockchain gateway 116 may store a list of user and entity account IDs that are authorized to read from or write to the blockchain. When a request is received to read from or write to the blockchain, blockchain gateway 116 determines if a user or entity account ID included in the request matches a stored list of account IDs that are permitted to read from or write to the blockchain. Any applicable authorization procedure may be performed to verify that an account ID included in a request is permitted to read from or write to the blockchain.

When blockchain gateway 116 determines that a user or entity account is permitted to write to or read from the blockchain, blockchain gateway 116 may write data to the blockchain on behalf of the user or entity account ID included in the request. Similarly, blockchain gateway 116 may read data from the blockchain on behalf of the user or entity account ID included in the request and transmit the data, or a subset thereof, to a computing device associated with the requesting user or account ID. Blockchain gateway 116 may expose further functionality, as further discussed herein.

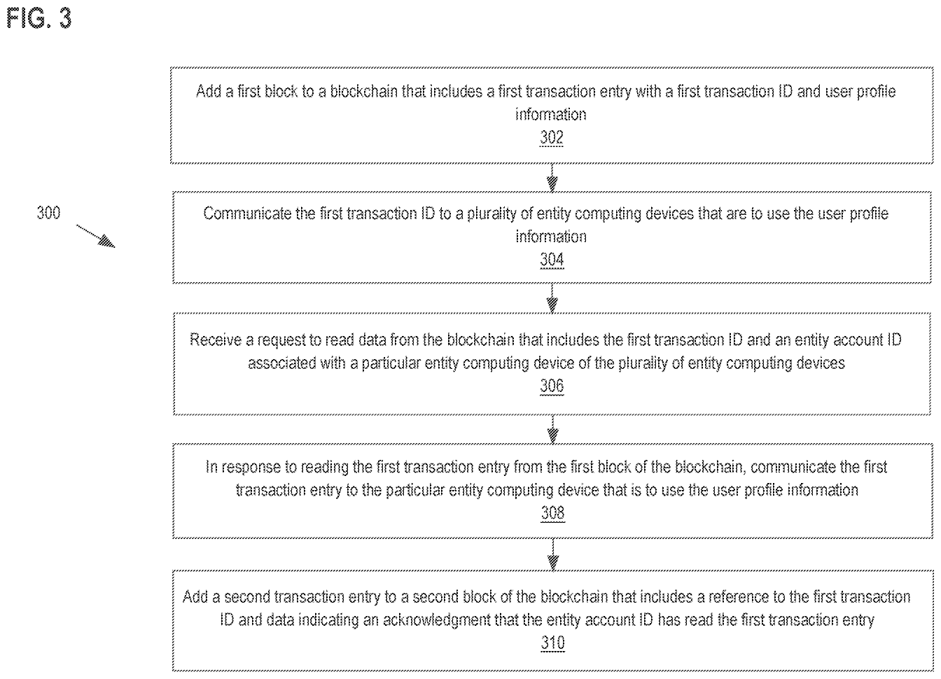

FIG. 3 depicts a method for controlling access to user profile information using a blockchain, in an example embodiment. FIG. 3 is described at the same level of detail that is ordinarily used, by persons of skill in the art to which this disclosure pertains, to communicate among themselves about algorithms, plans, or specifications for other programs in the same technical field. While the algorithm or method of FIG. 3 shows a plurality of steps, the algorithm or method described herein may be performed using any combination of one or more steps of FIG. 3 in any order, unless otherwise specified.

For purposes of illustrating a clear example, FIG. 3 is described herein in the context of FIG. 1, but the broad principles of FIG. 3 can be applied to other systems having configurations other than as shown in FIG. 1. Further, FIG. 3 and each other flow diagram herein illustrates an algorithm or plan that may be used as a basis for programming one or more of the functional modules of FIG. 1 that relate to the functions that are illustrated in the diagram, using a programming development environment or programming language that is deemed suitable for the task. Thus, FIG. 3 and each other flow diagram herein are intended as an illustration at the functional level at which skilled persons, in the art to which this disclosure pertains, communicate with one another to describe and implement algorithms using programming. The flow diagrams are not intended to illustrate every instruction, method object or sub step that would be needed to program every aspect of a working program, but are provided at the high, functional level of illustration that is normally used at the high level of skill in this art to communicate the basis of developing working programs.

In an embodiment, blockchain gateway 118 includes programmatic instructions configured to control access to a blockchain supported by blockchain network 102. For example, if user computing device 114 or entity computing device 118 desires to publish a transaction to a blockchain supported by blockchain network 102 or read a block of the blockchain supported by blockchain network 102, blockchain gateway 116 includes programmatic instructions to control such access attempts.

At step 302, a first block is added to a blockchain. The first block includes a first transaction entry that includes a first transaction ID and user profile information. In some embodiments, the user profile information may be encrypted using an encryption key. For example, user computing device 114 may generate a request to publish a transaction entry to a blockchain. The request may be generated at user computing device 114 or blockchain gateway 118 using a graphical user interface (GUI) that is associated with programmatic logic that receives input via GUI from a user of user computing device 114 and formats the received input into a transaction entry that includes a first transaction ID and user profile information. Blockchain gateway 118 may transmit the request to publish the transaction entry to a node of blockchain network 102, and the receiving node may publish the transaction entry to a blockchain associated with blockchain network 102.

At step 304, the first transaction ID is communicated to a plurality of entity computing devices that are to use the user profile information. Each of the plurality of entity computing devices may be represented by an entity account that corresponds to a business entity. For example, an entity account may be represented by a Facebook account, a Twitter account, or any business entity that is to use the user profile information included in the transaction entry of the first block. Communicating the first transaction ID may be accomplished by the blockchain gateway 116 or user computing device 114 transmitting the information to the plurality of entity computing devices.

At step 306, a request to read data from the blockchain is received. The request includes the first transaction ID and an entity account ID associated with a particular entity computing device of the plurality of entity computing devices. For example, entity computing device 118 may generate a request to read data from the blockchain. The request may be generated at entity computing device 118 or blockchain gateway 116 using a graphical user interface (GUI) that is associated with programmatic logic that receives input via GUI from a user of entity computing device 118 and formats the received input into read request that includes a first transaction ID and an entity account ID. The read request may be received by blockchain gateway 118 which may parse to request to determine the first transaction ID and the entity account ID included in the request before performing further actions.

At step 308, in response to reading the first transaction entry from the first block of the blockchain, the first transaction entry is communicated to the particular entity computing device that is to use the user profile information. For example, after receiving the request to read data from the blockchain in step 306, blockchain gateway 118 may read the transaction entry that corresponds to the first transaction ID specified in the request received in step 306. Communicating the first transaction entry may be accomplished by the blockchain gateway 116 transmitting information from the transaction entry to the particular entity computing device that issued the request.

In some embodiments, blockchain gateway 116 may read the first transaction entry that corresponds to the first transaction ID and determine that the first transaction entry includes a whitelist of entity account IDs that are permitted to read the first transaction entry or a blacklist of entity account IDs that are not permitted to read the first transaction entry. In case of a whitelist, blockchain gateway 116 determines whether the entity account ID included in the request from step 306 is included in the whitelist of entity account IDs from the first transaction entry. In response to determining that the entity account ID is included in the whitelist of entity account IDs from the first transaction entry, the first transaction entry is communicated to the particular entity computing device. In response to determining that the entity account ID is not included in the whitelist of entity account IDs from the first transaction entry, the request to read data from the blockchain is denied by blockchain gateway 116.

In some embodiments, blockchain gateway 116 may read the first transaction entry that corresponds to the first transaction ID and determine that the first transaction entry includes preferences regarding one or more fields of the user profile data. For example, a field may specify a preference that the respective field should only be read by certain entity account IDs. Blockchain gateway 116 may be programmed or configured to identify the preference from the user profile data and determine that the entity account ID included in the read request is not restricted by the preference. In response, the first transaction entry may be communicated to the particular entity computing device that is to use the user profile information. Alternatively, blockchain gateway 116 may identify that a particular field of the first transaction entry specifies a preference that restricts the requesting entity account ID from reading the particular field, but the remaining fields of the first transaction entry may not include such a restriction. In this scenario, blockchain gateway 116 is programmed or configured to only communicate the remaining fields of the first transaction entry that are not restricted to the requesting entity account ID.

In some embodiments, user profile data may be encrypted and stored in the blockchain, as discussed in flow 200 on FIG. 2. In this situation, when a request is received from a user computing device 114 or entity computing device 118 to publish a transaction entry to a blockchain supported by blockchain network 102, blockchain gateway 116 is programmed or configured to encrypt payload data of the transaction entry, including user profile data, and then submit the transaction entry with the encrypted payload data to the blockchain network 102 for publishing to the blockchain.

Additionally, when a request is received from a user computing device 114 or entity computing device 118 to read a transaction entry from a blockchain supported by blockchain network 102, blockchain gateway 116 is programmed or configured to decrypt payload data of the transaction entry, including user profile data, determine if any preferences, whitelists, or blacklists are included in the decrypted payload data, and then based on the determination, transmit the decrypted payload data of the transaction entry to the requesting user computing device 114 or entity computing device 118.

At step 310, a second transaction entry is added to a second block of the blockchain. The second transaction entry includes a reference to the first transaction ID and data indicating an acknowledgment that the entity account ID has read the first transaction entry. The acknowledgment that the entity account ID has read the first transaction entry serves as a read receipt that is stored in the blockchain. For example, blockchain gateway 116 may generate a request to publish the second transaction entry to the blockchain. The request may be generated at blockchain gateway 116 in response to communicating the first transaction entry to the particular entity computing device that is to use the user profile information. Blockchain gateway 118 may transmit the request to publish the second transaction entry to a node of blockchain network 102, and the receiving node may publish the transaction entry to the blockchain associated with blockchain network 102.

The above described embodiments provide the benefit of securely and efficiently controlling access to user profile information by multiple entity accounts. For example, by using a blockchain gateway to control access to a blockchain, all accesses including reads or writes to the blockchain can be recorded in the blockchain, providing immutable transparency to owners of personal data regarding who is accessing their data and how often it is being accessed. Additionally, a blockchain gateway provides the benefit of specifying and enforcing restrictions for each piece of personal data stored in a blockchain. Furthermore, by using a blockchain in tandem with a blockchain gateway that controls access to the blockchain, the blockchain advantageously provides cryptographically safe storage and immutability for the user profile data that is stored on the blockchain. For example, since each block of a distributed blockchain contains a hash of the previous block before it, any unauthorized changes to data such as user profile information stored within the blockchain produces changes in the hash of each block in the chain. Therefore, unauthorized changes can easily be detected through the use of blockchain to store user profile information.

### Hardware Overview

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

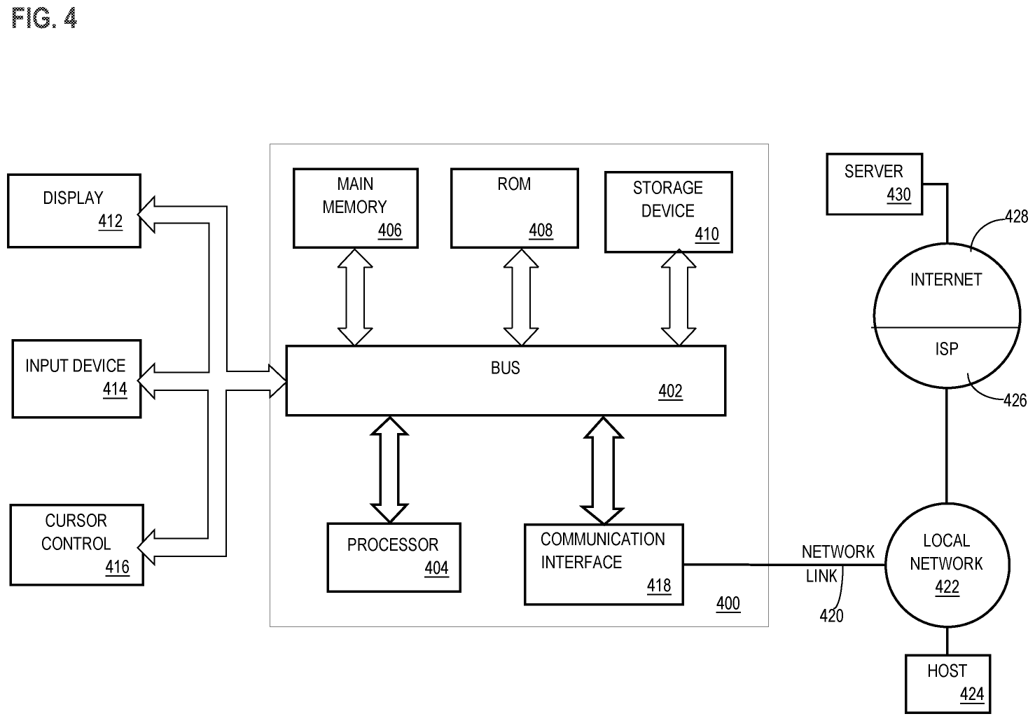

FIG. 4 is a block diagram that illustrates an example computer system with which an embodiment may be implemented. In the example of FIG. 4, a computer system 400 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 400 includes an input/output (I/O) subsystem 402 which may include a bus and/or other communication mechanism(s) for communicating information and/or instructions between the components of the computer system 400 over electronic signal paths. The I/O subsystem 402 may include an I/O controller, a memory controller and at least one I/O port. The electronic signal paths are represented schematically in the drawings, for example as lines, unidirectional arrows, or bidirectional arrows.

At least one hardware processor 404 is coupled to I/O subsystem 402 for processing information and instructions. Hardware processor 404 may include, for example, a general-purpose microprocessor or microcontroller and/or a special-purpose microprocessor such as an embedded system or a graphics processing unit (GPU) or a digital signal processor or ARM processor. Processor 404 may comprise an integrated arithmetic logic unit (ALU) or may be coupled to a separate ALU.

Computer system 400 includes one or more units of memory 406, such as a main memory, which is coupled to I/O subsystem 402 for electronically digitally storing data and instructions to be executed by processor 404. Memory 406 may include volatile memory such as various forms of random-access memory (RAM) or other dynamic storage device. Memory 406 also may be used for storing temporary variables or other intermediate information during execution of instructions to be executed by processor 404. Such instructions, when stored in non-transitory computer-readable storage media accessible to processor 404, can render computer system 400 into a special-purpose machine that is customized to perform the operations specified in the instructions.

Computer system 400 further includes non-volatile memory such as read only memory (ROM) 408 or other static storage device coupled to I/O subsystem 402 for storing information and instructions for processor 404. The ROM 408 may include various forms of programmable ROM (PROM) such as erasable PROM (EPROM) or electrically erasable PROM (EEPROM). A unit of persistent storage 410 may include various forms of non-volatile RAM (NVRAM), such as FLASH memory, or solid-state storage, magnetic disk or optical disk such as CD-ROM or DVD-ROM, and may be coupled to I/O subsystem 402 for storing information and instructions. Storage 410 is an example of a non-transitory computer-readable medium that may be used to store instructions and data which when executed by the processor 404 cause performing computer-implemented methods to execute the techniques herein.

The instructions in memory 406, ROM 408 or storage 410 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 400 may be coupled via I/O subsystem 402 to at least one output device 412. In one embodiment, output device 412 is a digital computer display. Examples of a display that may be used in various embodiments include a touch screen display or a light-emitting diode (LED) display or a liquid crystal display (LCD) or an e-paper display. Computer system 400 may include other type(s) of output devices 412, alternatively or in addition to a display device. Examples of other output devices 412 include printers, ticket printers, plotters, projectors, sound cards or video cards, speakers, buzzers or piezoelectric devices or other audible devices, lamps or LED or LCD indicators, haptic devices, actuators or servos.

At least one input device 414 is coupled to I/O subsystem 402 for communicating signals, data, command selections or gestures to processor 404. Examples of input devices 414 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 416, which may perform cursor control or other automated control functions such as navigation in a graphical interface on a display screen, alternatively or in addition to input functions. Control device 416 may be a touchpad, a mouse, a trackball, or cursor direction keys for communicating direction information and command selections to processor 404 and for controlling cursor movement on display 412. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 414 may include a combination of multiple different input devices, such as a video camera and a depth sensor.

In another embodiment, computer system 400 may comprise an internet of things (IoT) device in which one or more of the output device 412, input device 414, and control device 416 are omitted. Or, in such an embodiment, the input device 414 may comprise one or more cameras, motion detectors, thermometers, microphones, seismic detectors, other sensors or detectors, measurement devices or encoders and the output device 412 may comprise a special-purpose display such as a single-line LED or LCD display, one or more indicators, a display panel, a meter, a valve, a solenoid, an actuator or a servo.

When computer system 400 is a mobile computing device, input device 414 may comprise a global positioning system (GPS) receiver coupled to a GPS module that is capable of triangulating to a plurality of GPS satellites, determining and generating geo-location or position data such as latitude-longitude values for a geophysical location of the computer system 400. Output device 412 may include hardware, software, firmware and interfaces for generating position reporting packets, notifications, pulse or heartbeat signals, or other recurring data transmissions that specify a position of the computer system 400, alone or in combination with other application-specific data, directed toward host 424 or server 430.

Computer system 400 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 400 in response to processor 404 executing at least one sequence of at least one instruction contained in main memory 406. Such instructions may be read into main memory 406 from another storage medium, such as storage 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 410. Volatile media includes dynamic memory, such as memory 406. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 402. Transmission media can also take the form of acoustic or light waves, such as those generated during radio-wave and infra-red data communications.

Various forms of media may be involved in carrying at least one sequence of at least one instruction to processor 404 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 400 can receive the data on the communication link and convert the data to a format that can be read by computer system 400. For instance, a receiver such as a radio frequency antenna or an infrared detector can receive the data carried in a wireless or optical signal and appropriate circuitry can provide the data to I/O subsystem 402 such as place the data on a bus. I/O subsystem 402 carries the data to memory 406, from which processor 404 retrieves and executes the instructions. The instructions received by memory 406 may optionally be stored on storage 410 either before or after execution by processor 404.

Computer system 400 also includes a communication interface 418 coupled to bus 402. Communication interface 418 provides a two-way data communication coupling to network link(s) 420 that are directly or indirectly connected to at least one communication networks, such as a network 422 or a public or private cloud on the Internet. For example, communication interface 418 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 422 broadly represents a local area network (LAN), wide-area network (WAN), campus network, internetwork or any combination thereof. Communication interface 418 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 418 sends and receives electrical, electromagnetic or optical signals over signal paths that carry digital data streams representing various types of information.

Network link 420 typically provides electrical, electromagnetic, or optical data communication directly or through at least one network to other data devices, using, for example, satellite, cellular, Wi-Fi, or BLUETOOTH technology. For example, network link 420 may provide a connection through a network 422 to a host computer 424.

Furthermore, network link 420 may provide a connection through network 422 or to other computing devices via internetworking devices and/or computers that are operated by an Internet Service Provider (ISP) 426. ISP 426 provides data communication services through a world-wide packet data communication network represented as internet 428. A server computer 430 may be coupled to internet 428. Server 430 broadly represents any computer, data center, virtual machine or virtual computing instance with or without a hypervisor, or computer executing a containerized program system such as DOCKER or KUBERNETES. Server 430 may represent an electronic digital service that is implemented using more than one computer or instance and that is accessed and used by transmitting web services requests, uniform resource locator (URL) strings with parameters in HTTP payloads, API calls, app services calls, or other service calls. Computer system 400 and server 430 may form elements of a distributed computing system that includes other computers, a processing cluster, server farm or other organization of computers that cooperate to perform tasks or execute applications or services. Server 430 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 430 may comprise a web application server that hosts a presentation layer, application layer and data storage layer such as a relational database system using structured query language (SQL) or no SQL, an object store, a graph database, a flat file system or other data storage.

Computer system 400 can send messages and receive data and instructions, including program code, through the network(s), network link 420 and communication interface 418. In the Internet example, a server 430 might transmit a requested code for an application program through Internet 428, ISP 426, local network 422 and communication interface 418. The received code may be executed by processor 404 as it is received, and/or stored in storage 410, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening several instances of the same program often means more than one process is being executed. Multitasking may be implemented to allow multiple processes to share processor 404. While each processor 404 or core of the processor executes a single task at a time, computer system 400 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

What is claimed is:

1. A method for providing access control to user profile information stored in a blockchain, comprising:
adding, to a first block of the blockchain, a first transaction entry that includes:
a first transaction ID of the first transaction entry, and
user profile information;
communicating, to a plurality of entity computing devices that are to use the user profile information, the first transaction ID;
receiving a request to read data from the blockchain, the request including the first transaction ID of the first transaction entry and an entity account ID associated with a particular entity computing device of the plurality of entity computing devices;
in response to the request to read data from the blockchain, reading the first transaction entry from the first block;
in response to reading the first transaction entry from the first block, communicating, to the particular entity computing device that is to use the user profile information, the first transaction entry; and
adding, to a second block of the blockchain, a second transaction entry that includes a reference to the first transaction ID and data indicating an acknowledgment that the entity account ID has read the first transaction entry.

2. The method of claim 1, wherein the first transaction entry includes a whitelist of entity account IDs that are permitted to read the first transaction entry.

3. The method of claim 1, further comprising: in response to receiving the request to read data from the blockchain, reading the first transaction entry from the first block of the blockchain and determining whether the entity account ID is included in a whitelist of entity account IDs from the first transaction entry.

4. The method of claim 3, further comprising: in response to determining that the entity account ID is included in the whitelist of entity account IDs from the first transaction entry, communicating, to the particular entity computing device, the first transaction entry.

5. The method of claim 3, further comprising:
receiving a particular request to read data from the blockchain, the particular request including the first transaction ID of the first transaction entry and a particular entity account ID;
in response to determining that the particular entity account ID is not included in the whitelist of entity account IDs from the first transaction entry, denying the particular request to read data from the blockchain.

6. The method of claim 1, wherein:
the user profile information is encrypted using an encryption key; and
reading the first transaction entry from the first block comprises:
decrypting the user profile information using a decryption key that is able to decrypt information encrypted with the encryption key.

7. The method of claim 1, further comprising:
receiving a request to add the first transaction entry to the blockchain, the request including a user account ID;
verifying that the user account ID is authorized to write to the blockchain;
wherein the first transaction entry is added to the first block of the blockchain in response to verifying that the account ID is authorized to write to the blockchain.

8. The method of claim 1, further comprising verifying that the entity account ID is authorized to read from the blockchain prior to reading the first transaction entry from the first block.

9. A method for propagating updates to user profile information, comprising:
adding, to a blockchain, a first block that includes:
a first transaction ID, and
a first version of user profile information encrypted using a first encryption key;
communicating, to a plurality of entity computing devices that are to use the user profile information, the first transaction ID and a first decryption key that is able to decrypt information encrypted with the first encryption key; and
updating the user profile information by adding, to the blockchain, a second block that refers to the first transaction ID and includes a second version of the profile information encrypted using the first encryption key.

10. The method of claim 9, further comprising:
updating the user profile information by adding, to the blockchain, a third block that refers to the first transaction ID and includes a third version of the profile information encrypted using a second encryption key that is different from the first encryption key;
communicating, to a subset of the plurality of entity computing devices, a second decryption key that is able to decrypt information encrypted with the second encryption key;
wherein at least one of the plurality of entity computing devices is not included in the subset.

11. The method of claim 9, wherein the first block includes a whitelist that specifies one or more entity account IDs that are permitted to access the first version of user profile information.

12. The method of claim 9, wherein the first block includes one or more preferences that specify restrictions regarding one or more fields of the first version of user profile information.

13. One or more non-transitory computer-readable media storing instructions which, when executed by one or more processors, cause:
adding, to a first block of a blockchain, a first transaction entry that includes:
a first transaction ID of the first transaction entry, and
user profile information;
communicating, to a plurality of entity computing devices that are to use the user profile information, the first transaction ID;
receiving a request to read data from the blockchain, the request including the first transaction ID of the first transaction entry and an entity account ID associated with a particular entity computing device of the plurality of entity computing devices;
in response to the request to read data from the blockchain, reading the first transaction entry from the first block;
in response to reading the first transaction entry from the first block, communicating, to the particular entity computing device that is to use the user profile information, the first transaction entry; and
adding, to a second block of the blockchain, a second transaction entry that includes a reference to the first transaction ID and data indicating an acknowledgment that the entity account ID has read the first transaction entry.

14. The one or more non-transitory computer-readable media of claim 13, wherein the first transaction entry includes a whitelist of entity account IDs that are permitted to read the first transaction entry.

15. The one or more non-transitory computer-readable media of claim 13, further comprising instructions for: in response to receiving the request to read data from the blockchain, reading the first transaction entry from the first block of the blockchain and determining whether the entity account ID is included in a whitelist of entity account IDs from the first transaction entry.

16. The one or more non-transitory computer-readable media of claim 15, further comprising instructions for: in response to determining that the entity account ID is included in the whitelist of entity account IDs from the first transaction entry, communicating, to the particular entity computing device, the first transaction entry.

17. The one or more non-transitory computer-readable media of claim 15, further comprising instructions for:
receiving a particular request to read data from the blockchain, the particular request including the first transaction ID of the first transaction entry and a particular entity account ID;
in response to determining that the particular entity account ID is not included in the whitelist of entity account IDs from the first transaction entry, denying the particular request to read data from the blockchain.

18. The one or more non-transitory computer-readable media of claim 13, wherein:
the user profile information is encrypted using an encryption key; and
reading the first transaction entry from the first block comprises:
decrypting the user profile information using a decryption key that is able to decrypt information encrypted with the encryption key.

19. The one or more non-transitory computer-readable media of claim 13, further comprising instructions for:
receiving a request to add the first transaction entry to the blockchain, the request including a user account ID;
verifying that the user account ID is authorized to write to the blockchain;
wherein the first transaction entry is added to the first block of the blockchain in response to verifying that the account ID is authorized to write to the blockchain.

20. The one or more non-transitory computer-readable media of claim 13, further comprising instructions for: verifying that the entity account ID is authorized to read from the blockchain prior to reading the first transaction entry from the first block.

21. One or more non-transitory computer-readable media storing instructions which, when executed by one or more processors, cause:
adding, to a blockchain, a first block that includes:
a first transaction ID, and
a first version of user profile information encrypted using a first encryption key;
communicating, to a plurality of entity computing devices that are to use the user profile information, the first transaction ID and a first decryption key that is able to decrypt information encrypted with the first encryption key; and
updating the user profile information by adding, to the blockchain, a second block that refers to the first transaction ID and includes a second version of the profile information encrypted using the first encryption key.

22. The one or more non-transitory computer-readable media of claim 21, further comprising instructions for:
updating the user profile information by adding, to the blockchain, a third block that refers to the first transaction ID and includes a third version of the profile information encrypted using a second encryption key that is different from the first encryption key;
communicating, to a subset of the plurality of entity computing devices, a second decryption key that is able to decrypt information encrypted with the second encryption key;
wherein at least one of the plurality of entity computing devices is not included in the subset.

23. The one or more non-transitory computer-readable media of claim 21, wherein the first block includes a whitelist that specifies one or more entity account IDs that are permitted to access the first version of user profile information.

24. The one or more non-transitory computer-readable media of claim 21, wherein the first block includes one or more preferences that specify restrictions regarding one or more fields of the first version of user profile information.
